(19) United States
(12) Patent Application Publication
(10) Pub. No.: US 2026/0061414 A1
(43) Pub. Date: Mar. 5, 2026

(54) DEVICES FOR FILTERING SMALL QUANTITIES OF LIQUID

(71) Applicant: HANS-WERNER HEINRICH, LUDWIGSFELDE (DE)

(72) Inventor: HANS-WERNER HEINRICH, LUDWIGSFELDE (DE)

(21) Appl. No.: 19/289,120

(22) Filed: Aug. 4, 2025

(30) Foreign Application Priority Data
Aug. 30, 2024 (DE) 10 2024 124 804.1

(51) Int. Cl. B01L 3/02

(52) U.S. Cl. CPC B01L 3/021; B01L 2200/026; B01L 2300/0681; B01L 2300/0832; B01L 2300/123

(57) ABSTRACT

A device for filtering a liquid. The device includes a first part and a second part. The first part has an upper surface, a lower surface, and a first volume having a first opening into the upper surface and a second opening into the lower surface of the first part. The second part has an upper surface, a lower surface, a second volume having a first opening into the upper surface and a second opening into the lower surface of the second part, and a filter which is arranged in a region of the second opening of the second part.

### CROSS REFERENCE TO PRIOR APPLICATIONS

Priority is claimed to German Patent Application No. DE 10 2024 124 804.1, filed Aug. 30, 2024. The entire disclosure of said application is incorporated by reference herein.

### FIELD

The present invention relates to a device for filtering small quantities of liquid, into which device a liquid can be introduced and in which a filter is arranged, and to a method for filtering liquids.

### BACKGROUND

Devices for filtering small quantities of liquid are conventionally known in syringes with filters and cell sieves. Pipettes are typically used in the laboratory sector to transport liquids. Corresponding liquid samples are sucked into the pipette and transferred to a device having a filter or sieve.

A syringe with a filter can alternatively be used, in which case the sequence of corresponding work steps changes. Filters must in this case be changed in a time-consuming manner. Prior art devices are furthermore often elaborately packaged, which involves a large outlay of material for paper and plastic packaging material.

### SUMMARY

An aspect of the present invention is to provide an easy-to-handle filter device that can be used using a pipette.

In an embodiment, the present invention provides a device for filtering a liquid. The device includes a first part and a second part. The first part comprises an upper surface, a lower surface, and a first volume which comprises a first opening into the upper surface and a second opening into the lower surface of the first part. The second part comprises an upper surface, a lower surface, a second volume which comprises a first opening into the upper surface and a second opening into the lower surface of the second part, and a filter which is arranged in a region of the second opening of the second part.

### BRIEF DESCRIPTION OF THE DRAWINGS

The present invention is described in greater detail below on the basis of embodiments and of the drawings in which:

FIG. 1 shows a schematic representation in a top view of an embodiment of a device according to the present invention;

FIG. 2 shows a schematic representation in a top view of a first part of the device according to FIG. 1;

FIG. 3 shows a schematic representation in a top view of a second part of the device according to FIG. 1;

FIG. 4 shows a schematic representation in a lateral view of the device according to FIG. 1;

FIG. 5 shows a schematic representation in a lateral view with an axis A-A;

FIG. 6 shows a sectional representation along the axis A-A according to FIG. 5;

FIG. 7 shows a detail B of the representation according to FIG. 6;

FIG. 8 shows a schematic representation of the first part of the device according to FIG. 2 in a plan view;

FIG. 9 shows a schematic representation of the first part of the device according to FIG. 2 as seen from below;

FIG. 10 shows a schematic representation of the second part of the device according to FIG. 3 in a plan view;

FIG. 11 shows a schematic representation of the second part of the device according to FIG. 3 as seen from below;

FIG. 12 shows a sectional representation of a further embodiment of the device along the axis A-A according to FIG. 5;

FIG. 13 shows a schematic representation of the second part of the device according to FIG. 12 in a plan view;

FIG. 14 shows a schematic representation of the second part of the device according to FIG. 12 as seen from below;

FIG. 15 shows a schematic representation of a further embodiment of the device in a lateral view with an axis A-A;

FIG. 16 shows a sectional representation along the axis A-A according to FIG. 15; and

FIG. 17 shows a flow diagram of an embodiment of a method according to the present invention.

### DETAILED DESCRIPTION

A first aspect of the present invention relates to a device for filtering liquids, the device having at least a first part and at least a second part, wherein the first part comprises a first volume and the second part comprises a second volume, wherein the first volume has a first opening into an upper surface and a second opening into a lower surface of the first part, wherein the second volume has a first opening into an upper surface and a second opening into a lower surface of the second part, and wherein the second part has a filter which is arranged in the region of the second opening of the second part.

The device according to the present invention advantageously provides for the convenient transfer of liquids from a sample vessel into the device. This provides a user-friendly possibility for filtering liquids that is convenient to use with a pipette. Compared with the prior art, the device is designed to be material-saving, simple, and stable, and provides a time-saving procedure compared with the prior art.

A cavity is provided in the device. This cavity corresponds to the second volume. In this cavity of up to 200 μl there can advantageously be received a corresponding liquid which is received into the device via a pipette which is inserted into the first part. The volume has the advantageous effect that a liquid reservoir is provided from which a uniform liquid flow via the filter is made possible. This also allows the entire filter surface to be used for filtration. The liquid is collected below the device for the purposes of the present invention. The filtered liquid is intended to be used further. The filtrate is discarded.

The device is in particular dimensioned so that the lower region of the second part is compatible with a mini-reaction vessel, for example, an Eppendorf® tube known to a person skilled in the art having a volume in the range from 1.5 to 2.0 ml. This allows the filtered liquid to be conveniently received below the device for further use.

The device is furthermore in particular dimensioned so that a pipette tip can be inserted into the opening in the upper region of the first part. The region for insertion of the pipette tip corresponds to the first volume. Respective devices can be provided for different pipette sizes.

A further advantage of the present invention is that the parts of the device, i.e., the first part and the second part, can be used separately. The second part can be combined with different first parts which can each be provided for different pipette tip sizes. The first part of the device can furthermore be used separately in combination with other filter devices that are commercially available. The first part is provided so that it matches with corresponding prior art filter devices.

The first part of the device can, for example, have in the region of the second opening, a first connecting element, and the second part can, for example, have in the region of the second opening, a second connecting element, wherein the first and second connecting elements are compatible with each other so that a stable connection between the first and the second part can be established. The first and second connecting elements advantageously allow a stable yet conveniently establishable connection. The first part in this case overlaps with the second part in the region of the connection so that the outer surface of the first part is directed toward and/or is in contact with an inner surface of the second part. This advantageously provides a stable contact between the first and the second connecting elements and thus a stable connection between the first part and the second part. The connection can be reversible. Reversible means that it can also again be released. The first and second connecting elements are in particular designed in the form of a click mechanism where the parts latch with each other, and where the connection can again be released via mechanical pressure. It is also possible for the first and second connecting elements to be adhesively bonded or welded to each other. The connection would in this case be irreversible. The two-part design advantageously provides the connection of differently dimensioned first parts, i.e., first parts designed for receiving differently sized pipette tips, with the same second part.

The first part of the device can, for example, have in the region of the upper surface, a larger diameter than in the region of the lower surface, wherein the transition between the diameters is formed gradually. A beveled design allows a stop function, in particular clamping, of the device when inserting the device into a mini-reaction vessel, wherein reaction vessels having different diameters can thereby be used.

The second part can, for example, in the region of the upper surface, have a larger diameter than in the region of the lower surface, and the transition between the diameters can, for example, be formed gradually. This also advantageously provides a stop function of the device when inserting into a mini-reaction vessel.

The filter can, for example, be an integral constituent part of the second part of the device. This means that the filter is inserted into the second part during the manufacturing process of the device.

The filter can, for example, also be adhesively bonded or welded to the lower surface of the second part of the device.

The material of the device can, for example, contain an elastic plastic. In other words, the material contains a synthetic polymer. An elastic plastic provides elasticity to the device which, when inserting the device into a mini-reaction vessel, advantageously allows for a pressing into the corresponding vessel. The polymers can, for example, be polypropylene, polyethylene and polyamide, without being limited thereto. Thermoplastic elastomers can, for example, be used. The thermoplastic elastomers can in particular have an elasticity of 55 A +/−20 A, i.e., in the range from 35 to 75 A. The material may, for example, contain silicone.

The filter can, for example, comprise a woven fabric which is composed of polymeric filaments or comprises a membrane. The material of the filter comprises at least one polymer, for example, polyethylene, polyethylene terephtalate, a polyamide, polyethersulfone, polytetrafluoroethylene, or polyvinylidene fluoride.

The lateral surface of the first and/or second part furthermore has a number of projections and grooves. During the filtration process, these advantageously provide for a pressure equalization between the collecting vessel and the environment by allowing air displaced by filtered liquid to escape laterally past the device through the grooves.

In an embodiment of the device, the second part can, for example, have a partition wall which is oriented perpendicular to the lower edge so that the second volume is subdivided into a first subregion and a second subregion. This design allows air to escape from the immediate filter region. This immediate filter region corresponds to the first subregion. The second subregion is in particular intended for the air displaced from the first subregion. This embodiment is particularly advantageous for devices with small-pored filter membranes, via which air can only escape slowly. The partition wall can, for example, be arranged so that a liquid to be filtered that is introduced from the direction of the first part flows into the first subregion of the second volume, and the second subregion of the second volume is not filled with the liquid. The air can escape via the filter in the region of the second subregion.

In an embodiment of the device, the first part and the second part can, for example, be fixedly connected so that the device is formed in one piece, and the filter is an integral constituent part of the device. A stable filter device can thereby advantageously be provided.

A second aspect of the present invention relates to a method for filtering a liquid via a device according to the present invention, the method comprising the following steps:
assembling the device,
arranging the device in a collecting vessel,
inserting a pipette into the upper opening of the first part,
introducing a liquid from the pipette into the device, and
collecting the liquid in the collecting vessel.

The advantages of the method correspond to the advantages of the device according to the present invention.

The present invention is explained in greater detail below with reference to the drawings.

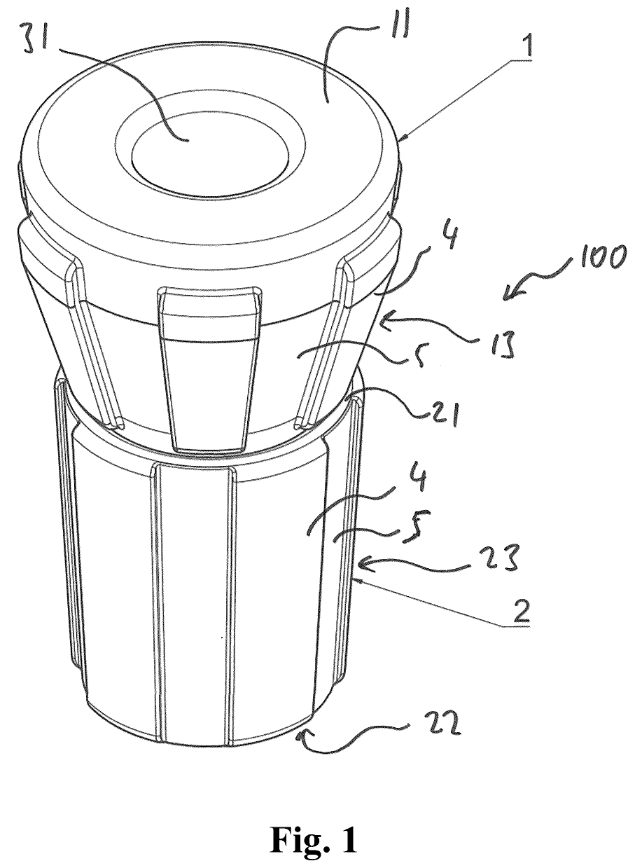

One embodiment of a device 100 according to the present invention as shown in FIG. 1 has a first part 1 and a second part 2. The device 100 in FIG. 1 is here represented in a top view, i.e., viewed obliquely from above. The device 100 is provided for filtering a liquid.

The material of the device is a thermoplastic elastomer with an elasticity of about 35 to 75 A. The material contains, for example, polypropylene and rubber. Other possible alternative polymers or polymers to be combined are polyethylene and polyamides. The material may also comprise silicone.

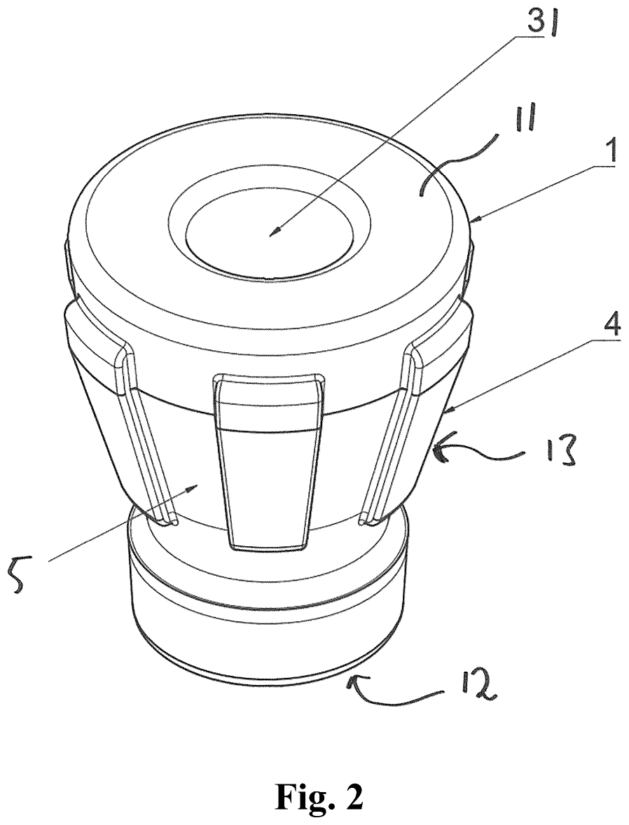

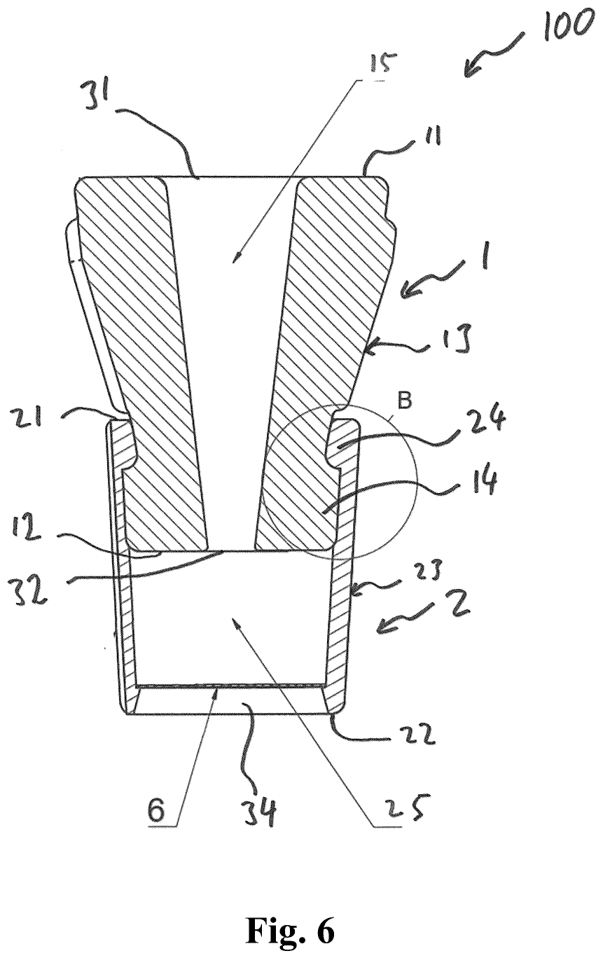

The first part 1 has an upper surface 11 with a first opening 31, a lower surface 12 (see FIG. 2) with a second opening 32 (see FIG. 6) and a lateral surface 13. The lateral surface 13 is formed with projections 4 and grooves 5.

The first opening 31 of the first part 1 is provided to receive a pipette tip of a pipette, in particular a micropipette. The first opening 31 can in this case be provided in such a size that, for example, a tip of a 1 ml pipette, a tip of a 100 μl pipette, or a tip of a 10 μl pipette can be received. The shape of the first opening 31 can in this case taper from the upper surface 11 in the direction of the second opening 32 so that it corresponds in an accurately fitting manner to the shape of a corresponding pipette tip to be introduced.

The first part 1 has a larger diameter in the upper region than in the lower region. The diameter decreases gradually from the upper surface 11 to the lower surface 12. The difference between the diameters of the upper surface 11 and the lower surface 12 can, for example, be 1 to 30 %, for example, 5 to 25 %, for example, 10 to 20 %, and, for example, 15 %.

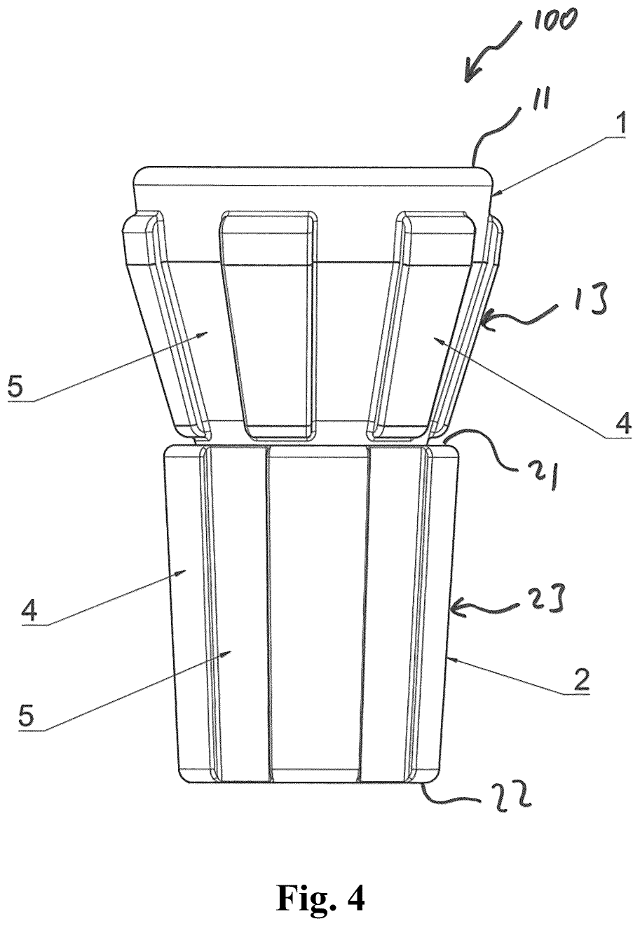

The second part 2 has an upper surface 21 with a first opening 33, a lower surface 22 with a second opening 34 (see FIG. 6) and a lateral surface 23. The lateral surface 23 is also formed here with projections 4 and grooves 5. The device 100 is provided to be inserted into a commercially available micro-reaction vessel which is known to a person skilled in the art, in which micro-reaction vessel a liquid filtered by the device 100 is to be collected. The diameter of the second part 2 in the lower region, i.e., in the region of the lower surface 22, is smaller than in the upper region, i.e., in the region of the upper surface 21. The second part 2 also tapers gradually from the upper surface 21 to the lower surface 22. The difference between the diameter of the upper surface 21 and that of the lower surface 22 is not as pronounced as in the first part 1. The difference between the diameters of the upper surface 21 and the lower surface 22 is between 1 and 10%, for example, 5%. The taper of both parts can in particular be seen in the lateral view according to FIG. 4. The diameter of the second part 2 in the region of the lower surface 22 is in this case smaller than the inside diameter of a micro-reaction vessel into which the device 100 is to be inserted. The changing diameter in the direction of the first part 1 allows for a gradual lodging, in other words, a clamping of the device 100, in a micro-reaction vessel. The significantly wider configuration of the first part 1, the diameter of which at least in the central lateral region of the lateral surface 13 is wider than the inside diameter of a corresponding micro-reaction vessel, thus provides a stop function which prevents the device 100 from slipping too far into a corresponding micro-reaction vessel.

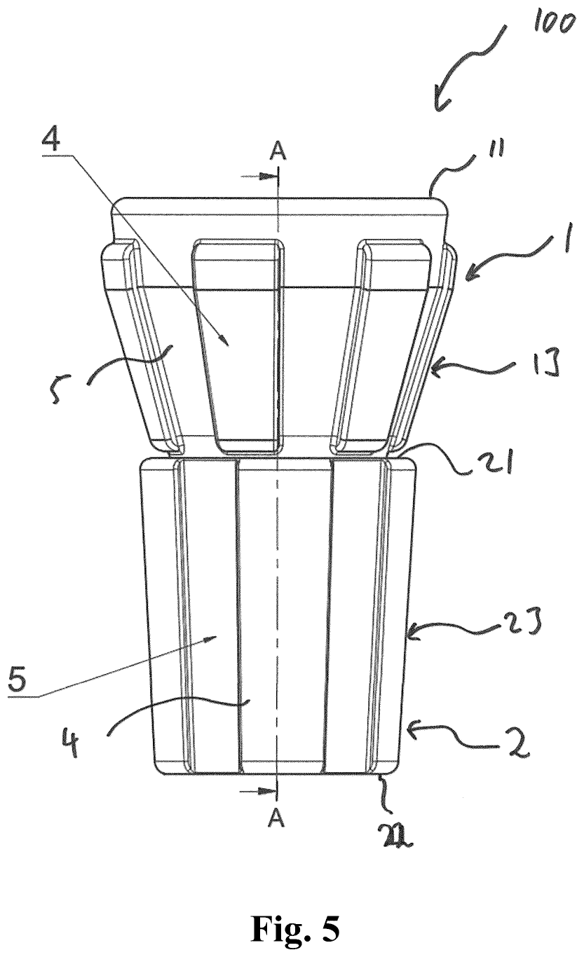

FIG. 5 corresponds to FIG. 4 with a drawn axis A-A. Along this axis A-A, the device 100 is shown as cut open in FIG. 6. In the first part 1 there is formed a first volume 15 which is provided for receiving a pipette tip. The shape of the first volume, which becomes narrower from the first opening 31 toward the second opening 32, is in this case adapted to the shape of a pipette tip. A second volume 25 is formed in the second part 2. A filter 6 is arranged in the region of the second opening 34 of the second part 2. The filter 6 is an integral constituent part of the second part 2, i.e., the filter 6 is connected to the remaining material of the second part 2 during the manufacture of the second part 2.

The filter 6 consists of a woven mesh of polymeric filaments, in particular polyethylene, without being limited thereto. Other polymers, such as, for example, polyethylene terephtalate, a polyamide, polyethersulfone, polytetrafluoroethylene or polyvinylidene fluoride, can be used alternatively or in combination with one another. The filter 6 may alternatively be a membrane made of these materials. The pore sizes may be provided in different sizes depending on the desired degree of purity of the liquid to be filtered. The pore sizes of the filter 6 can therefore be in the range from 10 nm to 1 mm, for example, 10 nm to 1 μm, 10 nm to 500 nm, 20 nm to 250 nm, 100 nm to 5 μm, 1 μm to 1 mm, or 10 μm to 500 μm.

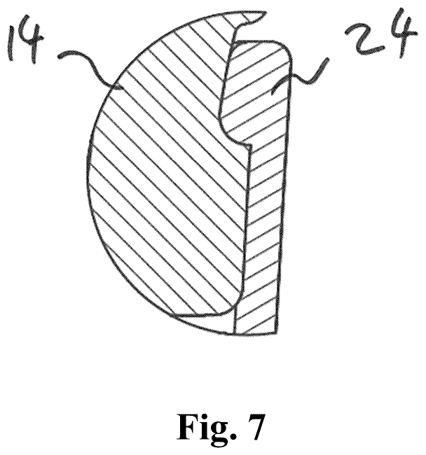

A region B is circled in FIG. 6 where the first part 1 uses a first connecting element 14 and the second part 2 uses a second connecting element 24 for connecting the first part 1 and the second part 2 to one another. This region B is cut out and shown enlarged in FIG. 7. The connecting elements 14, 24 are designed so that the first part 1 is pressed into the first opening 33 of the second part 2 by pressure exerted from the direction of the first surface 11 and the first connecting element 14 latches, i.e., “clicks in”, below the second connecting element 24. This connection can be released again by mechanical pressure on the lateral surface 13 of the first part 1.

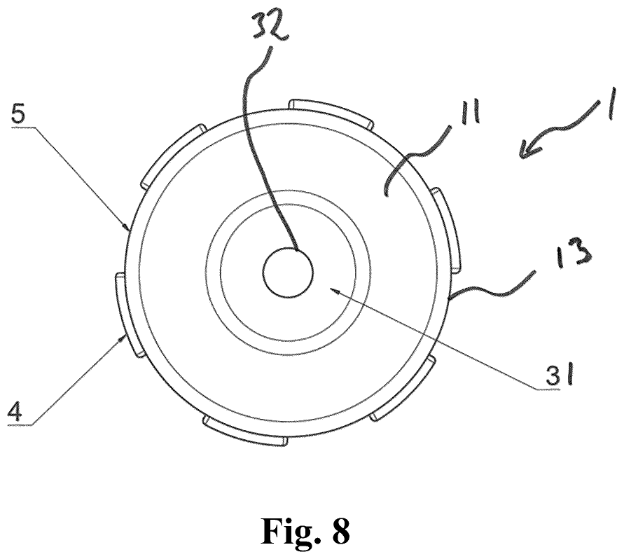

The first part 1 is represented in a plan view in FIG. 8. The first opening 31 is here formed in the center of the upper surface 11. The second opening 32 is shown centrally in the first opening 31. The lateral surface 13 has projections 4 and grooves 5.

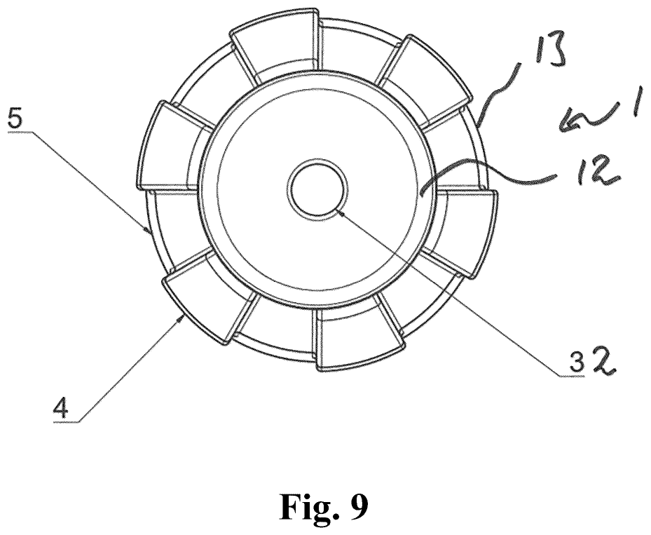

FIG. 9 shows the first part 1 represented in a view from below. The second opening 32 is here arranged in the center of the lower surface 12. The lateral surface 13 has projections 4 and grooves 5.

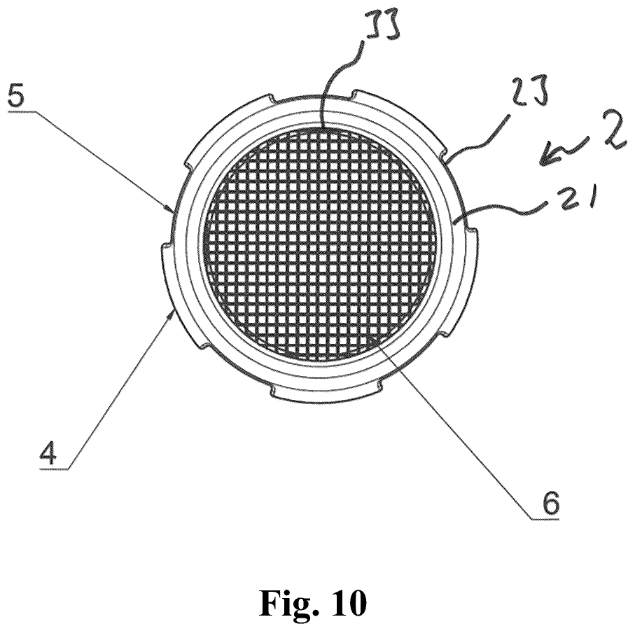

FIG. 10 shows the second part 2 represented in a plan view. The first opening 33 is here formed in the center of the upper surface 21. The filter 6 is arranged below the first opening 33 in the region of the second opening 34 (not shown here directly). The lateral surface 23 has projections 4 and grooves 5.

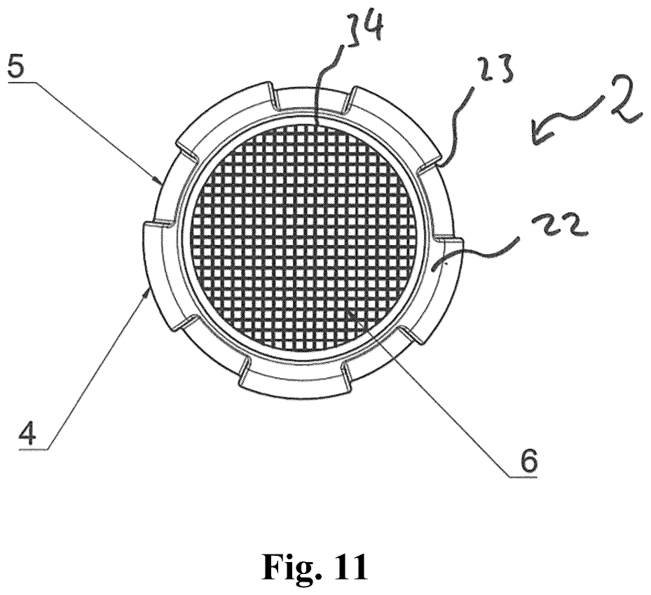

FIG. 11 shows the second part 2 as represented in a view from below. In the center of the lower surface 22 there is formed the second opening 34 in whose region the filter 6 is arranged. The lateral surface 23 has projections 4 and grooves 5.

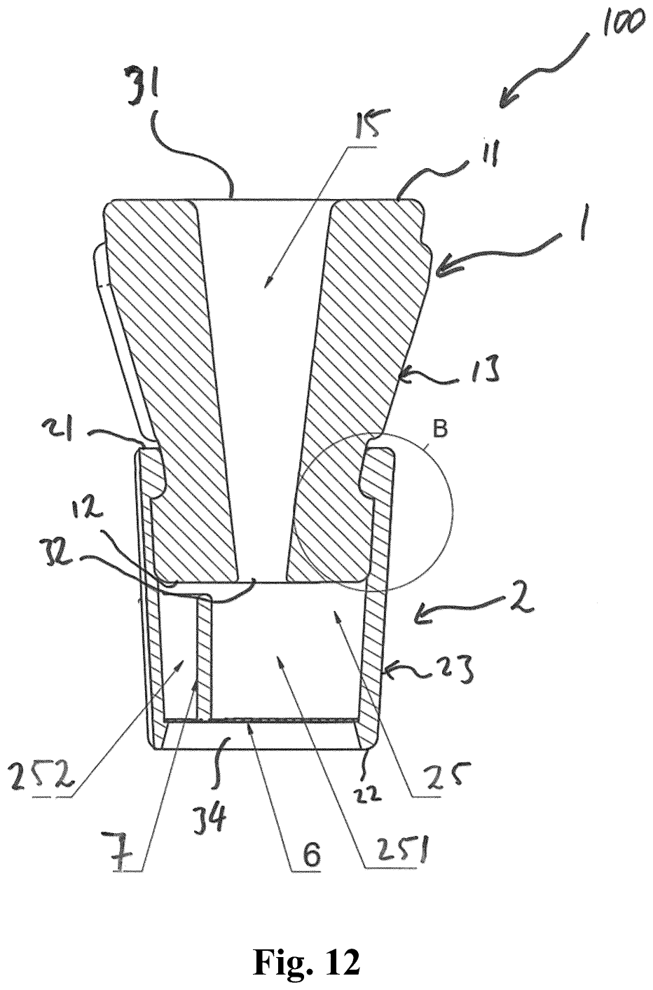

A second embodiment of the device 100 is represented in FIG. 12. Most of the features thereby correspond to the representation of FIG. 6. In FIG. 12, the device 100 has, as a further feature, a partition wall 7 which is formed in the region of the second volume 25 of the second part 2. The first part 1 corresponds to the first embodiment according to FIG. 1.

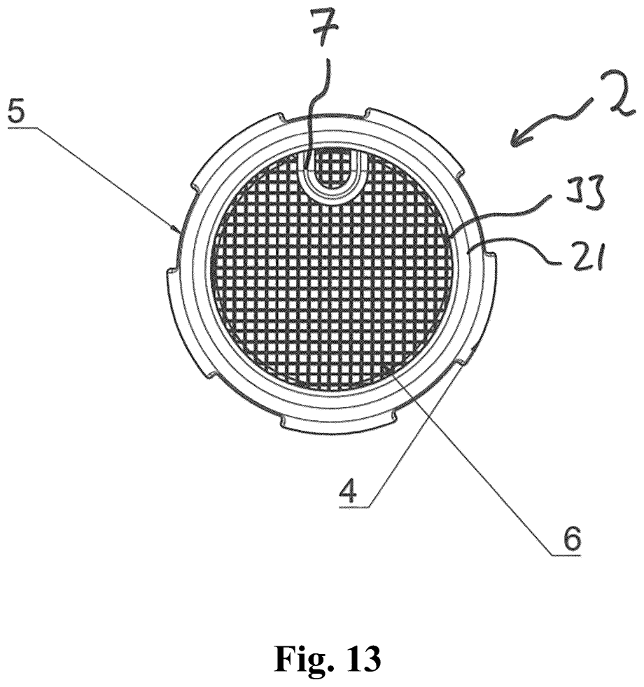

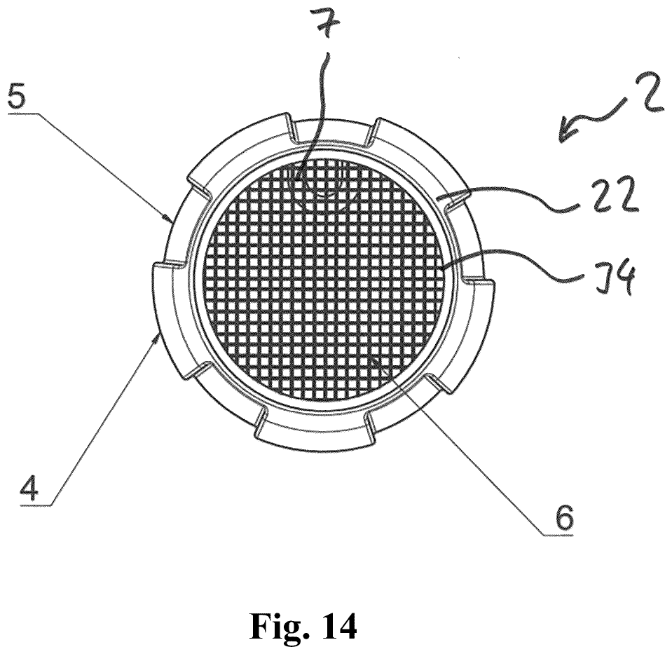

The partition wall 7 divides the second volume 25 into a first subvolume 251 and a second subvolume 252. The partition wall 7 has a semicircular shape as shown in FIG. 13 (plan view of the second part 2) and in FIG. 14 (view from below of the second part 2). The two subvolumes 251, 252 are connected to each other. The first subvolume 251 is the larger subvolume and is located directly below the second opening 32 of the first part 1 and is intended to receive a quantity of liquid that is to be filtered. The second subvolume 252 is the smaller subvolume and is intended to receive air displaced by introduced liquid so that it does not interfere with the filtration process. The displaced air can escape from the second subvolume 252 via the membrane.

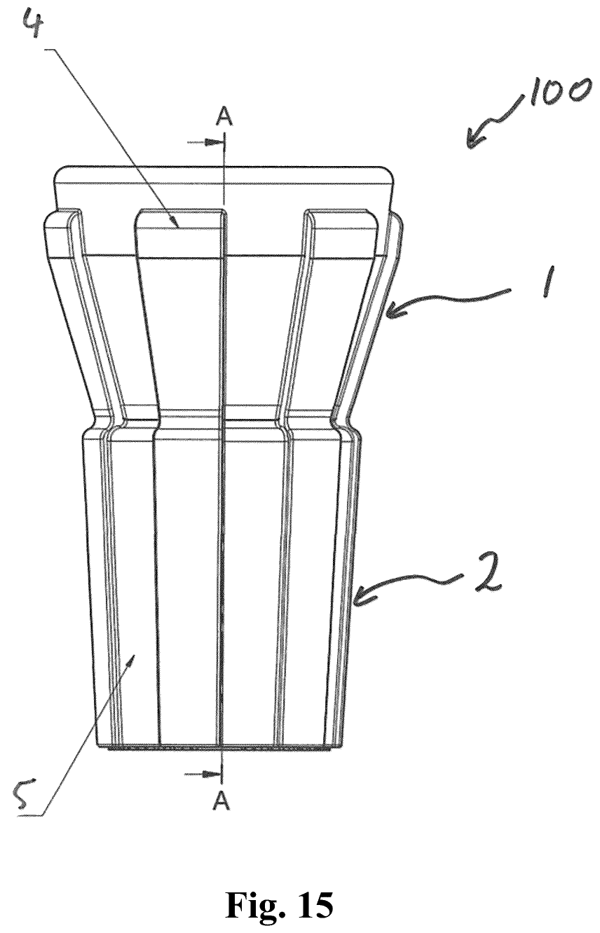

A third embodiment of the device 100 is represented in FIG. 15. The device 100 is in this case formed in one piece, i.e., the first part 1 and the second part 2 are fixedly connected to each other, i.e., from one piece, and thus are irreversibly connected. The device 100 also has the same features as the devices 100 according to FIGS. 1 and 12, such as the external features of the projections 4 and the grooves 5.

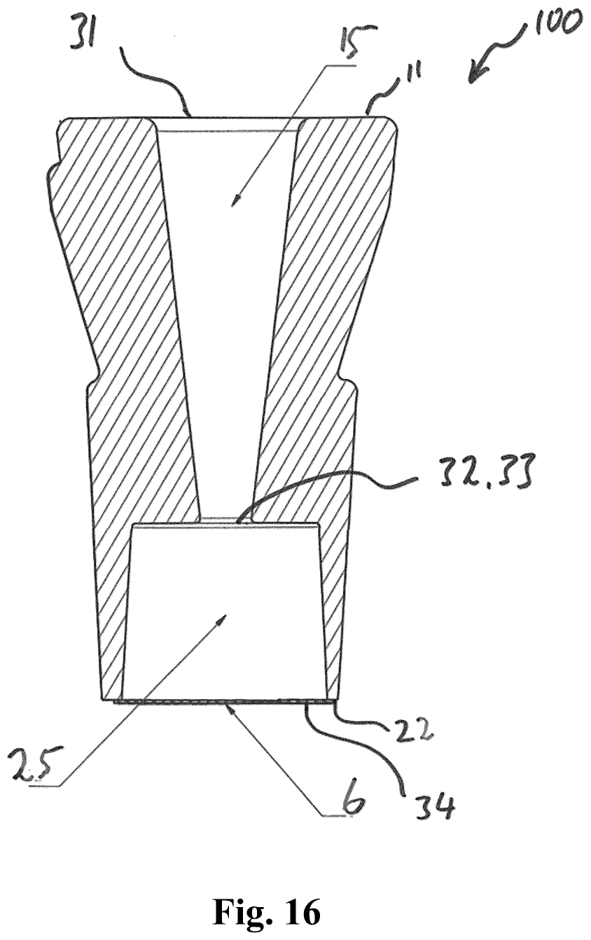

FIG. 16 shows the device 100 according to FIG. 15 as being cut open along the axis A-A. The device 100 in this case also has a first volume 15 which is connected to the second volume 25. The second opening 32 of the first part 1 is here identical to the first opening 33 of the second part 2, with these here forming the transition from the first volume 15 to the second volume 25. The filter 6 is attached to the lower surface 22 in the region of the second opening 34 of the second part 2, for example, by adhesive bonding or welding.

The embodiment according to FIGS. 15 and 16 also show that the second volume 25 may have a partition wall 7 which subdivides it into two subvolumes (not shown).

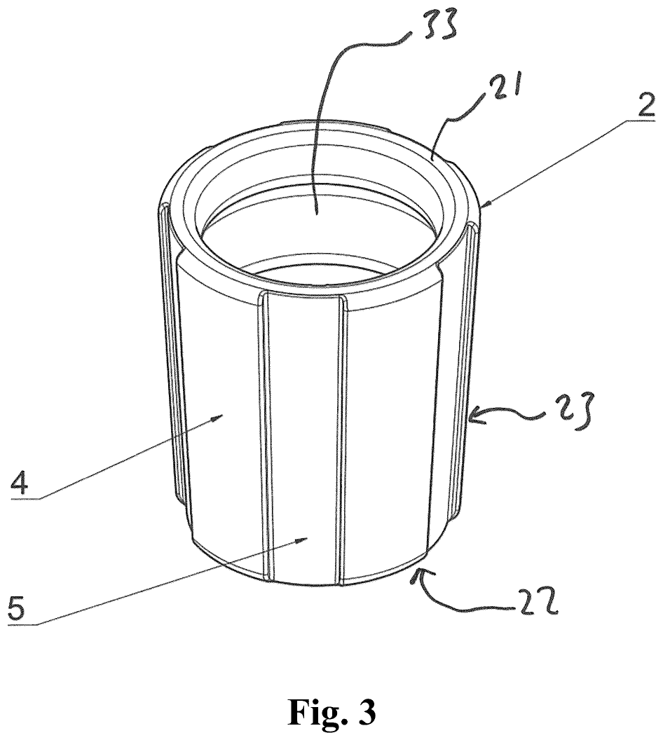

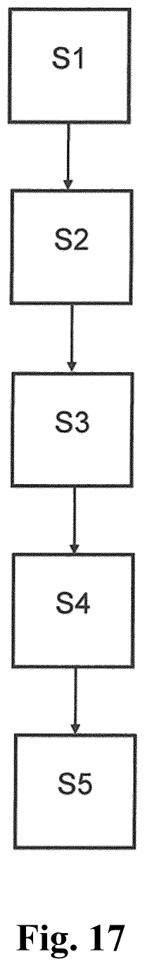

In a method according to FIG. 17, a device according to one of FIGS. 1 to 16 is used for filtering a liquid. In a first step S1, the device 100 is assembled from the first part 1 and the second part 2, unless it is provided in a single piece according to FIG. 12. In a second step S2, the device 100 is inserted into a collecting vessel, for example, a mini-reaction vessel having a volume of 1.5 ml. In a third step S3, a pipette with a 1 ml tip is inserted into the first opening 31 of the first part 1. In a fourth step S4, a liquid quantity of 200 μl is introduced from the pipette into the device. The liquid passes through the filter 6 and is collected in the mini-reaction vessel in a fifth step.

Further advantageous embodiments and refinements of the present invention result from the dependent claims, the drawings and the exemplary embodiments. The embodiments of the present invention can advantageously be combined. The present invention is not limited to embodiments described herein; reference should be had to the appended claims.

### LIST OF REFERENCE NUMERALS

100 Device
1 First part
2 Second part
4 Projection
5 Groove
6 Filter
7 Partition wall
11 Upper surface (of the first part)
12 Lower surface (of the first part)
13 Lateral surface (of the first par)
14 First connecting element (of the first part)
15 First volume
21 Upper surface (of the second part)
22 Lower surface (of the second part)
23 Lateral surface (of the second part)
24 Second connecting element (of the second part)
25 Second volume
31 First opening (of the first part)
32 Second opening (of the first part)
33 First opening (of the second part)
34 Second opening (of the second part)
251 First subregion (of the second volume)
252 Second subregion (of the second volume)

What is claimed is:

1. A device for filtering a liquid, the device comprising:
a first part which comprises an upper surface, a lower surface, and a first volume which comprises a first opening into the upper surface and a second opening into the lower surface of the first part; and
a second part which comprises an upper surface, a lower surface, a second volume which comprises a first opening into the upper surface and a second opening into the lower surface of the second part, and a filter which is arranged in a region of the second opening of the second part.

2. The device as recited in claim 1, wherein,
the first part further comprises, in a region of the second opening of the first part, a first connecting element,
the second part further comprises, in a region of the first opening of the second part, a second connecting element, and
the first connecting element and the second connecting are configured to be compatible with each other so as to establish a stable connection between the first part and the second part.

3. The device as recited in claim 1, wherein,
the first part has a first diameter in a region of the upper surface of the first part,
the first part has a second diameter in a region of the lower surface of the first part,
the first diameter is larger than the second diameter, and
a transition between the first diameter and the second diameter is arranged to be gradual.

4. The device as recited in claim 1, wherein,
the second part has a first diameter in a region of the upper surface of the second part,
the second part has a second diameter in a region of the lower surface of the second part,
the first diameter is larger than the second diameter, and
a transition between the first diameter and the second diameter is arranged to be gradual.

5. The device as recited in claim 1, wherein the filter is configured as an integral constituent part of the second part.

6. The device as recited in claim 1, wherein the filter is adhesively bonded or welded to the lower surface of the second part.

7. The device as recited in claim 1, wherein the device is made of a material which comprises an elastic plastic.

8. The device as recited in claim 7, wherein the material comprises a thermoplastic polymer.

9. The device as recited in claim 1, wherein the filter comprises a woven fabric which comprises polymeric filaments or a membrane.

10. The device as recited in claim 1, wherein at least one of,
the first part further comprises a lateral surface which comprises projections and grooves, and
the second part further comprises a lateral surface which comprises projections and grooves.

11. The device as recited in claim 1, wherein the second part further comprises a partition wall which is arranged perpendicular to the lower surface of the second part so that the second volume is subdivided into a first subregion and a second subregion.

12. The device as recited in claim 11, wherein the partition wall is further arranged so that the liquid to be filtered which is introduced from a direction of the first part flows into the first subregion of the second volume, and the second subregion of the second volume is not filled with the liquid.

13. The device as recited in claim 1, wherein,
the first part and the second part are fixedly connected so that the device is formed in one piece, and
the filter is an integral constituent part of the device.

14. A method for filtering a liquid, the method comprising:
assembling the device as recited in claim 1;
arranging the device in a collecting vessel;
inserting a pipette comprising the liquid into the upper opening of the first part;
introducing the liquid from the pipette into the device; and
collecting the liquid in the collecting vessel.
